(19) United States
(12) Patent Application Publication
(10) Pub. No.: US 2002/0168887 A1
(43) Pub. Date: Nov. 14, 2002

(54) Venting means for separable connectors

(76) Inventors: Paul Roscizewski, Eagle, WI (US); Randall Schoenwetter, Waukesha, WI (US); Mark Kadow, Pewaukee, WI (US)

Correspondence Address: FISH & RICHARDSON P.C., 1425 K STREET, N.W., 11TH FLOOR, WASHINGTON, DC, 20005-3500, US

(21) Appl. No.: 09/851,337

(22) Filed: May 9, 2001

(51) Int. Cl. H01R 4/60

(52) U.S. Cl. 439/206

(57) ABSTRACT

Apparatus for reducing the risk of flashover during loadbreak operations of insulated separable connectors. A substantial airtight seal is prevented between the collar of the bushing insert and the cuff of the mating component. The connection is vented to break any adhesion between the bushing insert and the mating component cuff and to provide a chamfered airway for atmospheric airflow during removal of the mating component. A latch ring is reformed to include at least one raised edge about its outer diameter. Each raised edge has the shape of a sharply angled ramp and extends outward. There may be four or six raised edges.

### TECHNICAL FIELD

This invention relates to loadbreak separable electrical connectors, and more particularly, to venting of these connectors to break the adhesion between the bushing insert and the overlapping cuff of the mating component.

### BACKGROUND

High-voltage separable connectors interconnect transformers and other electrical equipment to distribution networks or the like. Frequently, it is necessary to connect and disconnect the electrical connectors. These connectors typically feature an elbow component, which contains a male connector, and a bushing component, which contains a female connector. When the components are connected, elastomeric O-rings seal the connection.

Disconnecting energized connectors is an operation known as a loadbreak. A problem known as “flashover” has been known to occur while switching or separating loadbreak separable connectors. The male connector probe is typically maintained within the elbow, and the female connector contact is contained within the bushing. During a loadbreak operation, the elbow is pulled from the bushing using a hotstick to separate the components. This, in effect, creates an open circuit. During separation, flashover may occur when an arc from the energized connector extends rapidly to a nearby ground.

Existing connector designs contain a number of arc extinguishing components so that the devices can have loadbreak operations performed under energized conditions with no flashover to ground occurring. The object of caution is to control the arc and gases generated during loadmake and loadbreak operations. Even with these precautions, however, flashovers have occurred on rare occasions.

Flashovers commonly occur during the initial approximate one-inch of separation of the connectors from each other. The separation of the elbow from the bushing causes a partial vacuum to surround the energized components of the connector assembly. Because a partial vacuum presents a lower dielectric strength than that of air at atmospheric pressure, a flashover is more likely to occur at the moment that the elastomeric seal between the components is broken and before atmospheric pressure is reestablished around the energized portions of the components. Also, after being connected over a long period of time, the elbow may adhere to the bushing interface so that the connectors cannot be easily disengaged. This is known as a stuck condition, and greater force is required to separate the elbow, which may result in a more rapid change in pressure and dielectric strength in the air surrounding the energized components.

During a flashover, an electrical arc between the energized components and ground may result, which may cause damage to the equipment and possibly create a power outage. The problem of flashovers involves principally 25 KV and 35 KV loadbreak connectors but also may include 15 KV connectors.

Variations in the design of electrical connectors have been attempted to prevent flashovers. One adaptation has been to provide a groove or channel in the bushing insert shoulder. Another adaptation is to provide ribs on the transition shoulder of the bushing insert to prevent flashover. The plurality of ribs are circumferentially spaced along the transition shoulder portion of the bushing insert. Another design variation employs ribs that are spaced apart on the circumference of the outer surface of an indicator band.

### SUMMARY

Techniques are provided to reduce the risk of flashover during loadbreak operations.

Generally, when removing the mating component from the bushing insert, the connection is vented to break any adhesion between the bushing insert and the mating component cuff and to prevent flashover. A chamfered airway for atmospheric airflow is provided by the raised edges on the latch ring lifting the cuff away from the collar during removal of the mating component. A chamfered corner creates an opening larger than a groove, which reduces a problem associated with the use of a groove in that the groove could be clogged by lubricating grease.

A latch ring of a separable electrical connector is disposed over a forward portion of a collar of a bushing insert and over a shoulder of the bushing insert. The latch ring includes at least one raised edge extending outward beyond the circumference of the latch ring. Each raised edge has the shape of a sharply angled ramp and has dimensions of approximately 0.02 inches (height), 0.2 inches (width), and 0.5 inches (length). The at least one raised edge is formed on the latch ring during insulation-molding. Additionally, the at least one raised edge may be multiple raised edges evenly distributed along the circumference of the latch ring. In alternative implementations, there may be four or six raised edges, evenly distributed about the circumference of the latch ring. The latch ring may be part of a connector assembly including a bushing insert and a mating component. When the bushing insert and the mating component are assembled together, a cuff portion of the mating component overlaps the latch ring and a forward portion of the collar, and, as the mating component is removed from the bushing insert, the at least one raised edge pushes the cuff away from the latch ring and creates venting passages at the sides of the at least one raised edge.

The described techniques have particular application for electrical connections in the 15-35 KV voltage range. However, they also may be applied to other connections at other voltages.

The details of one or more implementations are set forth in the accompanying drawings and the description below. Other features and advantages will be apparent from the description and drawings, and from the claims.

### DESCRIPTION OF DRAWINGS

FIG. 1 is a cross-sectional view of an exemplary elbow shaped male connector.

FIG. 2 is a cross-sectional view of an exemplary bushing-type female connector configured to receive the male connector of FIG. 1.

FIG. 3 is a cross-sectional view of a bushing insert of the connector of FIG. 2.

FIG. 4A is an enlarged view of the bushing insert, a collar, and a latch ring of FIG. 3.

FIG. 4B is an enlarged view of the bushing insert, the collar, the latch ring, a mating component cuff, and an air cavity in an assembled form.

FIG. 5 is a view of an exemplary latch ring.

FIG. 6 is a view of the latch ring of FIG. 5 with multiple raised edges.

FIG. 7 is a view of a connector assembly using an implementation of a latch ring with multiple raised edges.

Like reference symbols in the various drawings indicate like elements.

### DETAILED DESCRIPTION

The construction and operation of conventional electrical connector assemblies, which are in many respects similar to the connectors described below, are well known and have been in widespread use commercially for many years. Reference is made, for example, to U.S. Pat. No. 5,221,220, which is incorporated by reference.

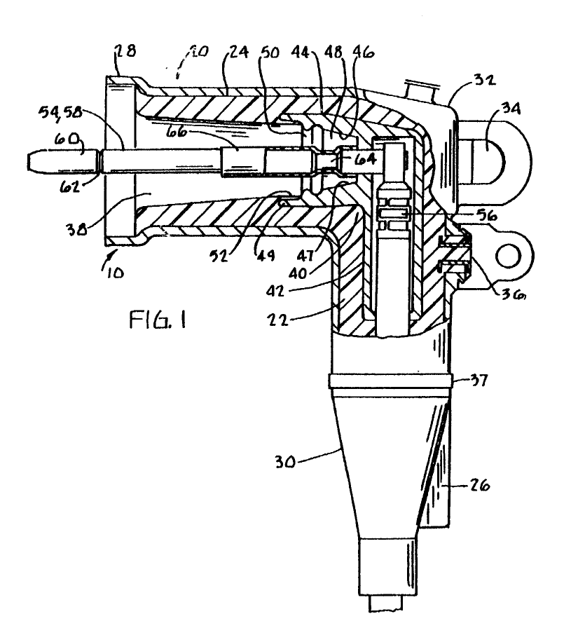

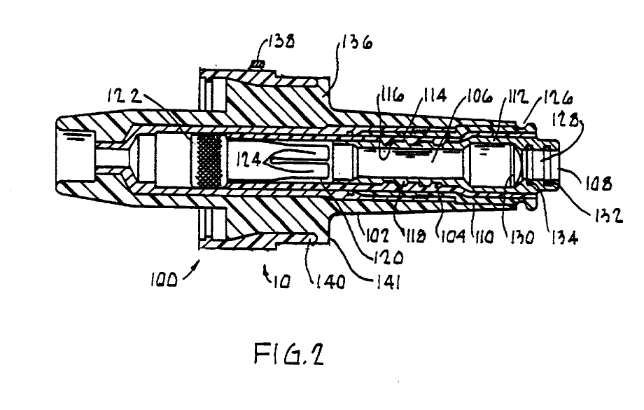

Referring to FIGS. 1 and 2, an electrical connector assembly 10 includes a male contact connector 20 (FIG. 1), such as an elbow connector, electrically connected to a portion of a high-voltage circuit (not shown), and a female contact connector 100 (FIG. 2), such as, for example, a bushing insert or connector, connected to another portion of the high-voltage circuit. As shown, the male contact connector 20 is in the form of a cable termination device, such as an elbow. Male and female contact connectors 20 and 100 are reversibly connectable and respectively interfit to achieve electrical connection. In one implementation, the connector assembly 10 is a 200 A, 25 KV class connector assembly. The construction and operation of electrical connector assemblies is well known in the art. Therefore, only relevant major components are described here.

The male connector 20 includes an elastomeric and electrically-resistive housing 22 constructed from a material such as EPDM (ethylene-propylene-dienemonomer) rubber, which is provided on its outer surface with a semiconductive shield layer 24 that may be grounded by a perforated grounding tab 26. The male connector 20 is generally elbow-shaped, with an upper horizontal portion 28 and a lower vertical portion 30 connected at a central portion 32. A pulling eye 34 extends horizontally from the central portion 32. An optional test point 36 is located along the lower portion 30. In addition, an annular band 37 surrounds the lower portion 30 to identify the male connector 20 as a loadbreak rated device.

A horizontally-oriented and generally conical bore 38 is disposed within the housing 22. A semiconductive insert 40 is contained within the housing 22 such that vertical portions 42 of the insert 40 extend into the lower portion 30 of the connector 20. A horizontally-disposed portion 44 of the insert 40 extends into the upper portion 28 of the connector 20 and presents an inner radial surface 46, which defines a conically-shaped recess 48. The insert 40 also presents an annular locking ring 50, which is inwardly directed within the recess 48 from the inner radial surface 46 of the insert 40. The locking ring 50 divides the inner radial surface 46 into a recessed area 47 and an extended area 49.

An insulative layer 52 of electrically-resistive material is disposed within the recess 48 of the insert 40. The insulative layer 52 is preferably also made of EPDM and may be unitarily molded with portions of the housing 22 during manufacture. The insulative layer 52 extends from the inner surface of the bore 38 along the inner surface 46 of the insert 40 to the locking ring 50 so that the extended area 49 of the inner surface 46 is insulated. Additionally, the recessed area 47 of the insert 40 may be insulated.

A male contact 54, which also is referred to as a probe assembly, is largely contained within the housing 22 and is aligned down the axis of the conical bore 38 of the insert 40. A conductor contact 56 is applied to a cable conductor (not shown) to make electrical contact with the cable conductor and is disposed within the lower portion of the male connector 20. The probe assembly 54 threadedly engages the conductor contact 56.

The probe assembly 54 also features a male contact element or probe 58 that is formed of a material such as copper and extends horizontally from the conductor contact 56 into the bore 38 of the upper portion 28 and the recess 48 of the insert 40. At the distal end of the probe extends an arc follower 60 of ablative material. In one implementation, the ablative material for the arc follower 60 is an acetal co-polymer resin loaded with finely divided melamine. The ablative material is typically injection molded onto a reinforcing pin (not shown). An annular junction recess 62 is disposed at the junction between the probe 58 and the arc follower 60. A second annular, radially-reduced recessed portion 64 is provided within the surface of the probe 58 to be nearly adjacent to the position of the locking ring 50 when the probe 58 has been assembled within the male connector 20. The recessed portion 64 is elongated along the longitudinal axis of the probe 58 and will typically measure between ½″-3″ in length.

An insulative sheath 66 is disposed about the portions of the exterior of the probe 58. The sheath 66 does not cover the entire length of the probe 58 as at least the distal end of the probe 58 proximate to the arc follower 60 must remain unsheathed so that an electrical connection may be made. The sheath 66 extends to and abuts the recessed area 47 of the inner radial surface 46 of insert 40.

FIG. 2 illustrates the female connector 100, which is implemented as a bushing insert composed generally of an outer electrically resistive layer 102 and an inner rigid, metallic, electrically conductive tubular assembly with associated components, referred to herein as a contact assembly 104. Though the construction and operation of female connectors of this type is well known in the art, major components will be described here. The female connector 100 is electrically and mechanically mounted to a bushing well (not shown) disposed on the enclosure of a transformer or other electrical equipment.

A central passageway 106 extends through the generally cylindrical contact assembly 104 and presents a forward opening 108. The passageway 106 is largely defined by a nosepiece 110 having a radially central portion 112 and a radially surrounding portion 114.

For purposes of description, the term “rear” shall mean the direction toward the bushing well of the electrical equipment and the term “forward” shall mean the direction toward the nose piece 110 and the male connector 20. The central portion 112 features an insulated chamber 116 having a metallic interior, which is radially surrounded by an arc interrupter 118. A female contact 120 is disposed toward the rear of the chamber 116 and is maintained in a radially central position by a copper knurled piston 122 through which the female contact 120 is electrically and mechanically coupled to a bushing well (not shown). The female contact 120 has forwardly extending collet fingers 124 which are fashioned to grip the probe 58 of the male connector 20. Nosepiece 110 has an external circumferential locking groove 126, which serves as a securing detent for a complimentary locking ring associated with the insert 40 of the male connector 20.

The forward end of the central passageway 106 includes an entrance vestibule 128 immediately rearward of opening 108. The vestibule 128 is separated from the chamber 116 by a hinged gas trap 130 that is operable between an open position, in which gas communication is possible between the chamber 116 and the vestibule 128, and a closed position, in which gas communication is substantially prevented between the chamber 116 and vestibule 128. The gas trap 130 is spring-biased toward the closed position and may be moved to its open position, as the probe 58 of the male connector 20 is disposed within the central passageway 106 through the vestibule 128 and into the chamber 116. A pair of elastomeric O-rings 132, 134 are located within the vestibule 128. When the connectors 20 and 100 are fully engaged, O-ring 132 is located in the recessed portion 64 of probe 58 in an uncompressed condition to prevent distortion of the elastomeric material making up the O-ring 132.

A portion of the outer electrically resistive layer 102 forms a radially enlarged section 136 that surrounds the copper tube 112. One or more ground tabs 138 are provided and are positioned at the radial exterior of the enlarged section 136. The enlarged section 136 also carries an annular semi-conductive shield or collar 140 about its circumference, which presents a forward bushing shoulder 141. In conventional electrical connector assemblies, this shield or collar 140 presents a ground plane to which an arc might tend toward during a flashover.

During a loadbreak or switching operation, the male connector 20 (i.e., the elbow and the probe assembly) is separated from the female connector 100 (i.e., the bushing insert). The connectors are energized when they are electrically connected to a high voltage distribution current. During loadbreak separation, contact occurs between the probe 58 and the female contact 120, which creates a mechanical drag between the probe 58 and the collet fingers 124 of female contact 120. Upon disconnection, arcing occurs as the probe 58 and the fingers 124 separate. The arcing is expected to be generally extinguished within the chamber 116 through the generation of arc-quenching gases by components within the chamber. These gases are directed inwardly within the central passageway 106 of the female connector 100. In a conventional connector assembly, arcing may unexpectedly and undesirably occur during loadbreak operation, with the arc extending from exposed conductive portions of the probe 58 or the insert 40 to a nearby available ground plane. In most cases, the ground plane is the annular semi-conductive shield 140 of the female connector 100, which is grounded through the ground tabs 138.

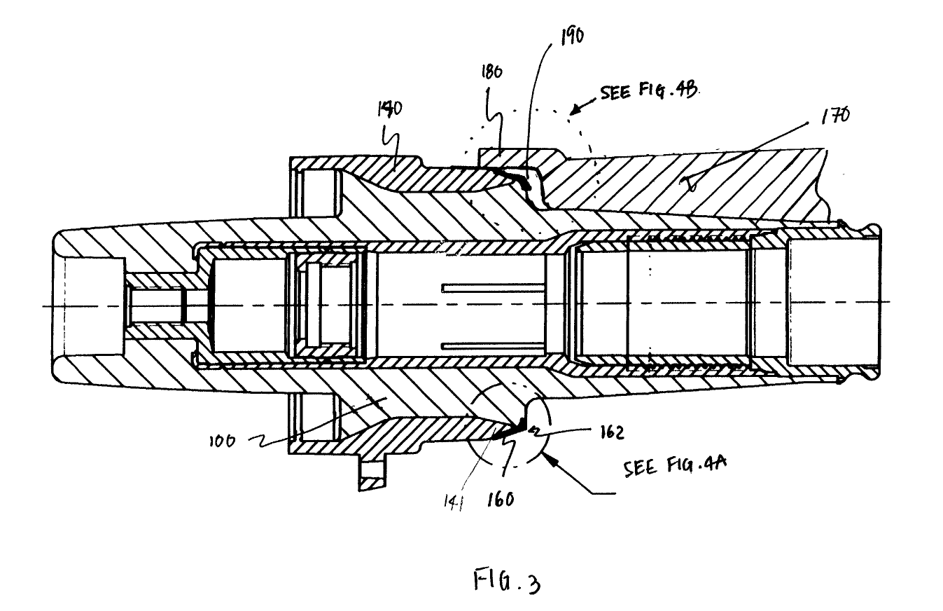

FIG. 3 illustrates a cross-section of a bushing insert 100. The bushing insert 100 includes a latch ring 160 disposed over a front portion of the collar 140 and the forward bushing shoulder 141 of the bushing insert 100. The latch ring 160 is chamfered to provide better venting. In particular, the latch ring 160 is reshaped in at least one location during insulation-molding to create raised edges 162, which are higher than the outer diameter of the collar 140 on the bushing insert 100. During insulation-molding, the latch ring 160, the collar 140, and then the bushing insert 100 are placed in the mold, which has indentations for the raised edges, and the latch ring is reshaped to include raised edges 162.

When the bushing insert 100 is assembled with the mating component 170, a cuff portion 180 overlaps the latch ring 160 and a portion of the collar 140, and an air cavity 190 is created between the mating component cuff 180 and the latch ring 160. A vacuum potentially could be created within the cavity 190 when the mating component 170 is removed from the bushing insert 100. However, the raised edges 162 provide a way to vent the cavity 190 and to break any adhesion between the bushing insert 100 and the overlapping cuff 180 of the mating component 170. This occurs because the raised edges 162 cause the overlapping cuff 180 to lift away from the bushing insert collar 140 so as to provide chamfered airways next to the edges 112 for atmospheric air flow to the cavity 190. As a result, any adhesion between the mating component 170 and the bushing insert collar 140 is broken and any vacuum in the cavity 190 is relieved to atmospheric pressure.

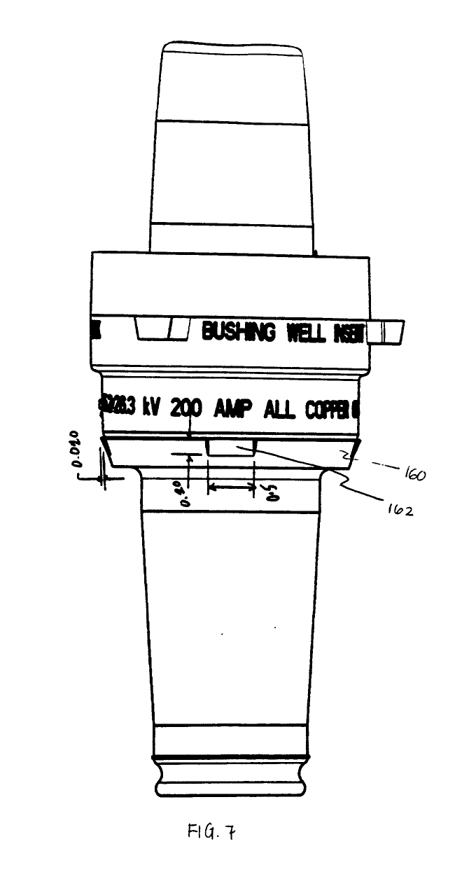

The raised edges 162 are evenly distributed about the circumference of the latch ring and each raised edge has the shape of a sharply angled ramp. In one implementation, there are four raised edges and each raised edge has dimensions of approximately 0.02 inches (height), 0.2 inches (width), and 0.5 inches (length).(see FIG. 7) Other implementations may have more (e.g., six) or fewer (e.g., two or one) raised edges, and may have edges with different dimensions.

Having a sharp edge on the raised edge provides an effective way of rapidly venting the connector assembly on disassembly to prevent flashover. Also, the cuff of the mating elbow is able to both overlap the bushing insert and form a good seal with the bushing insert over the at least one raised edge.

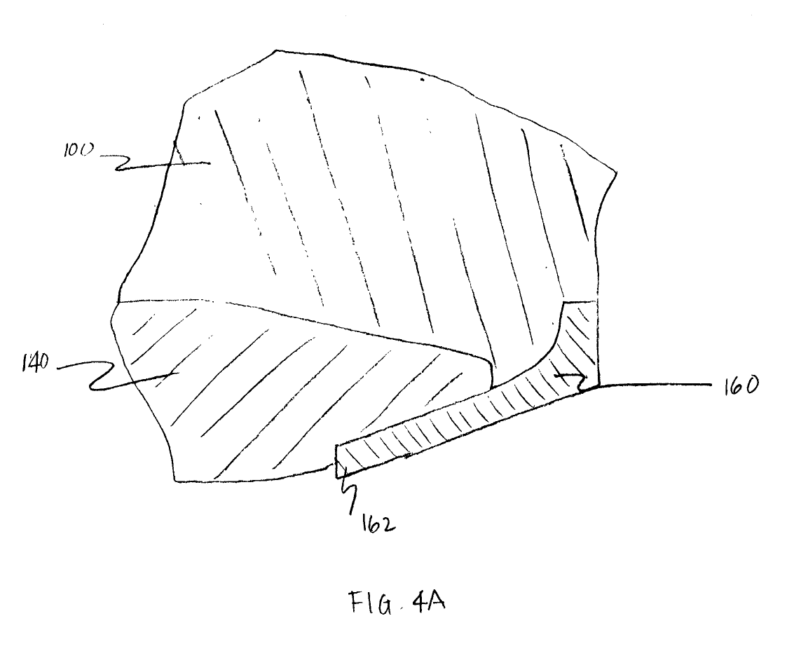

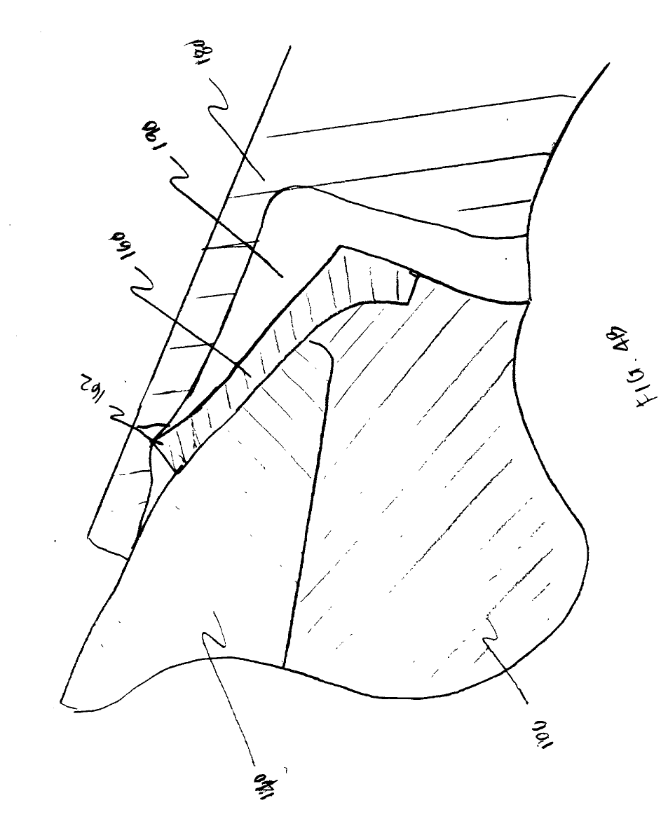

FIGS. 4A and 4B are enlarged views of the bushing insert 100, the collar 140, the latch ring 160 with at least one raised edge 162, the cuff 180 of the mating component 170, and the air cavity 190 created upon assembly of the bushing insert 100 and the mating component 170. As is seen, the raised edge protrudes beyond the outer diameter of the latch ring to extend the cuff 180 away from the collar 140.

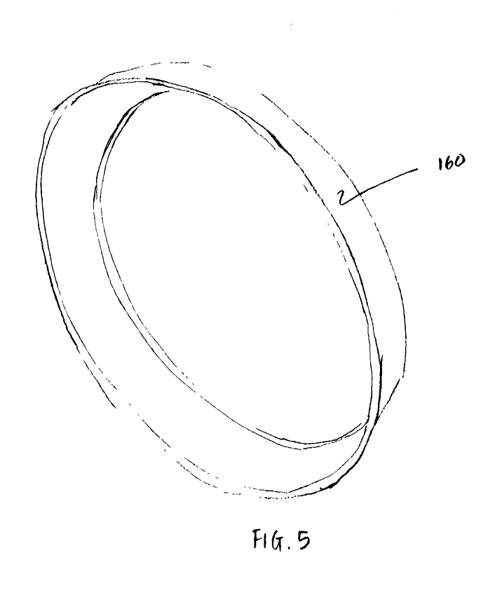

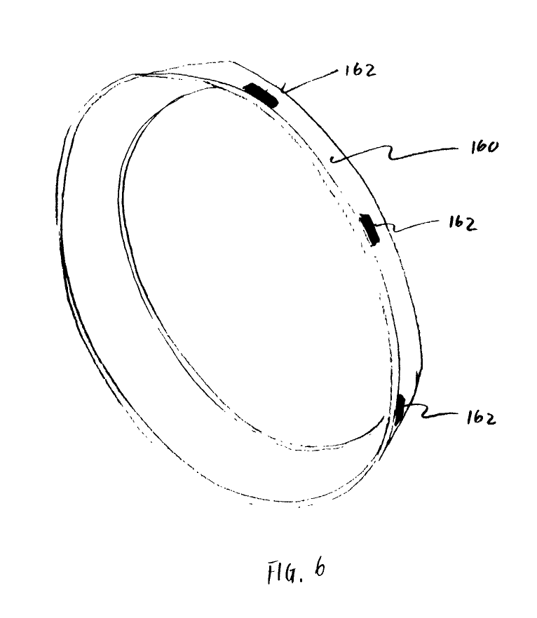

FIG. 5 is an exemplary latch ring 160. FIG. 6 shows the latch ring of FIG. 5 with multiple raised edges. As is seen, the raised edges 162 are distributed along the outer circumference of the latch ring 160. FIG. 7 (not to scale) shows an implementation of a latch ring with multiple raised edges in use with a connector assembly. The approximate dimensions of the raised edges are indicated in the figure.

A number of implementations have been described. Nevertheless, it will be understood that various modifications may be made. For example, the orientation, shape and/or size of the raised edges could be varied as long as the raised edges provided the necessary venting. Accordingly, other implementations are within the scope of the following claims.

What is claimed is:

1. A connector assembly, comprising:
a bushing insert, the bushing insert having a collar disposed thereon and a latch ring disposed over a forward end of the collar and over a shoulder of the bushing insert, the latch ring having at least one raised edge extending outward beyond the circumference of the latch ring; and
a mating component having a cuff portion,
wherein when the bushing insert and the mating component are assembled together, the cuff portion overlaps the latch ring and a forward portion of the collar, and, as the mating component is removed from the bushing insert, the at least one raised edge pushes the cuff away from the latch ring and creates venting passages at sides of the at least one raised edge.

2. The connector assembly of claim 1, wherein the at least one raised edge has the shape of a sharply angled ramp, the height of the at least one raised edge is approximately 0.02 inches; the width of the at least one raised edge is approximately 0.2 inches; and the length of the at least one raised edge is approximately 0.5 inches.

3. The connector assembly of claim 1, wherein the at least one raised edge comprises multiple raised edges evenly distributed along the outer circumference of the latch ring.

4. The connector assembly of claim 3, wherein the at least one raised edge consists of four raised edges evenly distributed along the outer circumference of the latch ring.

5. The connector assembly of claim 4, wherein each of the raised edges has the shape of a sharply angled ramp, the height of each raised edge is approximately 0.02 inches; the width of each raised edge is approximately 0.2 inches; and the length of each raised edge is approximately 0.5 inches.

6. The connector assembly of claim 3, wherein the at least one raised edge consists of six raised edges evenly distributed along the outer circumference of the latch ring.

7. The connector assembly of claim 6, wherein each of the raised edges has the shape of a sharply angled ramp, the height of each raised edge is approximately 0.02 inches; the idth of each raised edge is approximately 0.2 inches; and the length of each raised edge is approximately 0.5 inches.

8. The connector assembly of claim 1, wherein the at least one raised edge is reshaped into the latch ring during insulation-molding.

9. A latch ring for a separable electrical connector, the latch ring being disposed over a forward portion of a collar of a bushing insert and over a shoulder of a bushing insert, the latch ring comprising at least one raised edge extending outward beyond the circumference of the latch ring.

10. The latch ring of claim 9, wherein the at least one raised edge has the shape of a sharply angled ramp, the height of the at least one raised edge is approximately 0.02 inches; the width of the at least one raised edge is approximately 0.2 inches; and the length of the at least one raised edge is approximately 0.5 inches.

11. The latch ring of claim 9, wherein the at least one raised edge comprises multiple raised edges evenly distributed along the outer circumference of the latch ring.

12. The latch ring of claim 11, wherein the at least one raised edge consists of four raised edges evenly distributed along the outer circumference of the latch ring.

13. The latch ring of claim 12, wherein each of the raised edges has the shape of a sharply angled ramp, the height of each raised edge is approximately 0.02 inches; the width of each raised edge is approximately 0.2 inches; and the length of each raised edge is approximately 0.5 inches.

14. The latch ring of claim 11, wherein the at least one raised edge consists of six raised edges evenly distributed along the outer circumference of the latch ring.

15. The latch ring of claim 14, wherein each of the raised edges has the shape of a sharply angled ramp, the height of each raised edge is approximately 0.02 inches; the width of each raised edge is approximately 0.2 inches; and the length of each raised edge is approximately 0.5 inches.

16. The latch ring of claim 9, wherein the at least one raised edge is reshaped into the latch ring during insulation-molding.
